(19) United States
(12) Patent Application Publication
(10) Pub. No.: US 2008/0100631 A1
(43) Pub. Date: May 1, 2008

(54) METHOD AND SYSTEM FOR BLU-RAY/HD-DVD CHIP

(76) Inventors: Doug Grearson, Andover, MA (US); Glenn Giacalone, Andover, MA (US); David Wu, San Diego, CA (US); Tim Hellman, Concord, MA (US); Chris Payson, Bolton, MA (US); Reinhard Schumann, Exeter, NH (US)

Correspondence Address: MCANDREWS HELD & MALLOY, LTD, 500 WEST MADISON STREET, SUITE 3400, CHICAGO, IL, 60661, US

(21) Appl. No.: 11/870,199

(22) Filed: Oct. 10, 2007

Related U.S. Application Data
(60) Provisional application No. 60/863,509, filed on Oct. 30, 2006.

(51) Int. Cl. G06F 13/14; G06F 15/00

(52) U.S. Cl. 345/519; 345/501; 345/522

(57) ABSTRACT

In one embodiment, there is presented an integrated circuit. The integrated circuit comprises a transport processor and a host processor. The transport processor parses a media stream. The host processor determines whether a media stream is Blu-ray or HD-DVD and configures the transport processor based on whether the media stream is Blu-ray or HD-DVD.

### CROSS-REFERENCE TO RELATED APPLICATIONS/INCORPORATION BY REFERENCE

This application claims priority to “Method and System for a Blu-Ray/HD-DVD Chip”, Provisional Application for U.S. Patent Ser. No. 60/863,509, filed Oct. 30, 2006.

This application is also related to U.S. application Ser. No. 11/736,939 (Attorney Docket No. 18000US02).

Each of the above stated applications is hereby incorporated herein by reference in their entirety.

### BACKGROUND OF THE INVENTION

With the development of optical disk technology, larger amounts of audio and/or video data may be stored in a single disk when compared to other technologies such as magnetic recording, for example. Recent developments continue to expand the capabilities of optical disks by enabling higher data storage capacity within a single disk. For example, Blu-ray optical disk technology may utilize blue lasers to read and write to the disc. A Blu-ray disc may store substantially more data than, for example, a digital versatile disk (DVD) or a compact disk (CD), because of the shorter wavelength, approximately 405 nm, of the blue laser compared to the 650 nm wavelength for red lasers used by DVDs and the 780 nm wavelength for infrared lasers used by CDs. The use of shorter wavelengths enables more information to be stored digitally in the same amount of space. In comparison to high-definition digital versatile disk (HD-DVD), which also uses a blue laser, Blu-ray technology may enable more information capacity per optical disk layer.

For Blue-ray applications, coders/decoders (codecs) may be utilized to compress and/or decompress audio and video information to be stored and/or retrieved from optical discs. For video applications, standalone Blu-ray players may be able to decode various codec formats, such as, MPEG-2, which is also used for DVDs, H.264/AVC, a newer codec developed jointly by fISO/IEC's MPEG and ITU-T's VCEG, and/or VC-1, a codec based on Microsoft's Windows Media 9. For audio applications, Blu-ray players may support Dolby Digital, digital theater system (DTS), and linear pulse-coded modulation (PCM), up to 7.1 channels, for example. Blu-ray players may also support Dolby Digital Plus and lossless formats such as Dolby TrueHD and DTS HD, for example. In some instances, the Blu-ray player may need to support the linear PCM 5.1, Dolby Digital 5.1 and DTS 5.1 bitstream formats as one of them may be used as the sole soundtrack on a disc. For lossless audio in movies in the PCM, Dolby TrueHD or DTS-HD formats, Blu-ray discs may support encoding of up to 24-bit/192 kHz for up to six channels or up to 24-bit/96 kHz for up to eight channels.

In HD-DVD audio applications, up to 7.1 channels of surround sound may be mastered using the linear (uncompressed) PCM, Dolby Digital, and DTS formats also used on DVDs. Moreover, HD-DVD players may also support Dolby Digital Plus and lossless formats such as Dolby TrueHD and DTS HD, for example. On HD-DVD applications, the Dolby formats such as Dolby Digital or Dolby Digital Plus track, for example, may be used as the sole soundtrack on a disc. For lossless audio in movies in the PCM, Dolby TrueHD or DTS-HD formats, HD-DVD discs may support encoding of up to 24-bit/192 kHz for two channels or of up to 24-bit/96 kHz encoding for eight channels.

The emergence of two competing standards poses compatibility problems for playback systems. For example, a playback system that plays back HD-DVD discs may not play back Blu-ray discs. Similarly, a playback system that plays back Blu-ray discs may not play back HD-DVD discs.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a Blu-Ray/HD-DVD chip, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary integrated circuit in accordance with an embodiment of the present invention;

FIG. 2 is a block diagram of an exemplary transport processor in accordance with an embodiment of the present invention;

FIG. 3 is a block diagram of an exemplary integrated circuit in accordance with an embodiment of the present invention;

FIG. 4 is a block diagram of an exemplary integrated circuit in accordance with an embodiment of the present invention; and

FIG. 5 is a flow chart for playing back media in accordance with an embodiment of the present invention.

### DETAILED DESCRIPTION OF THE INVENTION

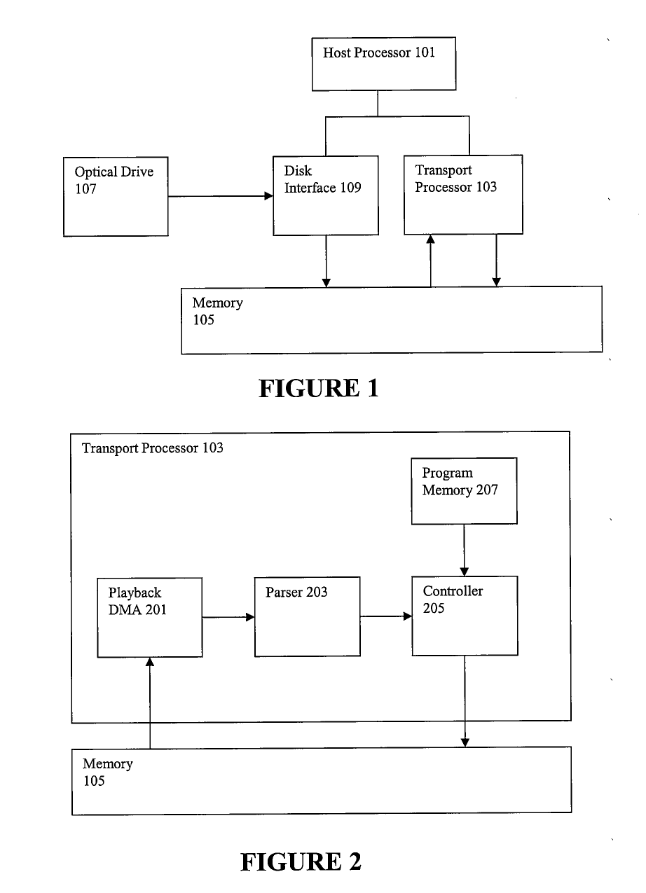

Referring now to FIG. 1, there is illustrated a block diagram of an exemplary integrated circuit in accordance with an embodiment of the present invention. The integrated circuit comprises a host processor 101 and a transport processor 103. The transport processor receives a media stream from which is either Blu-ray or HD-DVD. Depending on the type of stream that is received, the host processor 101 configures the transport processor 103 to parse the stream.

It is noted that Blu-ray uses transport stream packets while HD-DVD uses program stream packets. Accordingly, if the media is Blu-ray, the host processor 101 configures the transport processor 103 to parse transport stream packets. If the media is HD-DVD, the host processor 101 configures the transport processor 103 to parse program stream packets.

Referring now to FIG. 2, there is illustrated a block diagram of an exemplary transport processor. The transport processor 103 comprises a controller 201 and a program memory 203. The program memory 203 comprises a first portion 203a and a second portion 203b. The first portion 203a stores a program for parsing Blu-ray media streams. The second portion 203b stores second portion 203b that stores a program for parsing an HD-DVD media stream.

As noted above, Blu-ray uses transport stream packets while HD-DVD uses program stream packets. Accordingly, the first program stored in first portion 203a parses transport stream packets. The second program stored in the second portion 203b parses program stream packets.

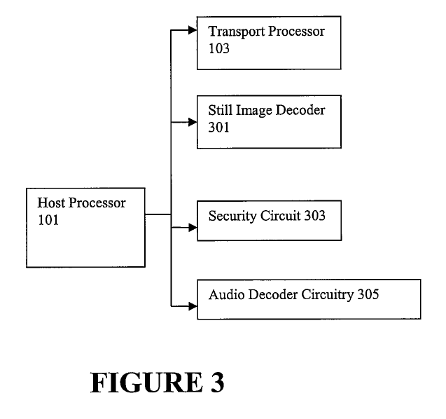

Referring now to FIG. 3, there is illustrated a block diagram of an exemplary integrated circuit in accordance with an embodiment of the present invention. The integrated circuit comprises a host processor 101, a transport processor 103, a still image decoder 301, a security circuit 303, and an audio decoder circuitry 305.

The transport processor 103 is capable of parsing both Blu-ray and HD-DVD media. The still image decoder 301 is capable of decoding still images for both Blu-ray and HD-DVD. The security circuit 303 is capable of decrypting both Blu-ray and HD-DVD media. The audio decoder circuitry 305 is capable of decoding audio media from both Blu-ray and HD-DVD media. The host processor 101 configures the transport processor 103, still image decoder 301, security circuit 303 and the audio decoder circuitry 305 based on whether a received media stream is Blu-ray or HD-DVD.

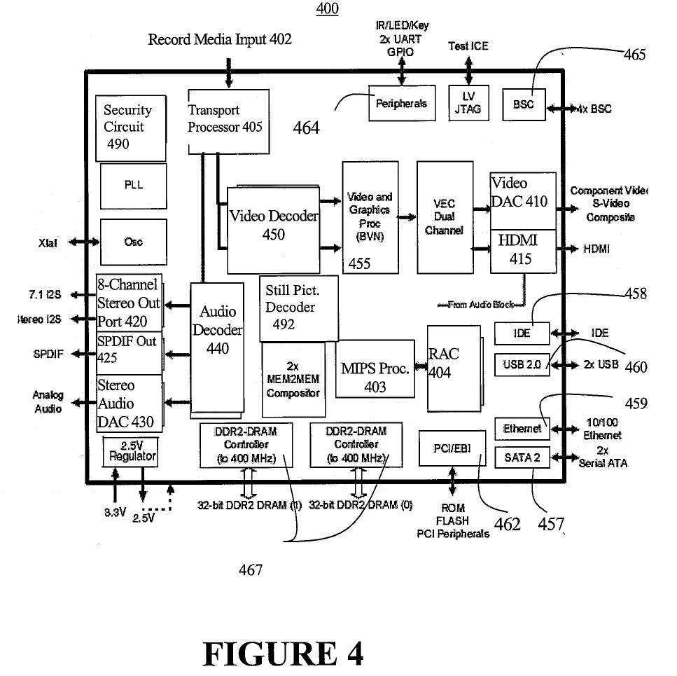

Referring now to FIG. 4, there is illustrated a block diagram of an exemplary DVD integrated circuit 400 in accordance with an embodiment of the present invention. The integrated circuit 400 can provided a highly integrated silicon platform for High Definition DVD players. It may be also be used in conjunction with a separate encoder.

The integrated circuit 400 receives a media stream at input 402 that can is either Blu-ray or HD-DVD media. The media can include audio and video, as well as data. The video data can be output in Component Video, or S-Video via video digital to analog converter (DAC) 410, and HDMI via HDMI output port 415. The analog data can be output in 7.1 Channel Output format or Stereo I2S format via 8 Channel/Stereo output port 420, SPDIF format from SPDIF output port 425, and analog via Stereo Audio Digital Audio Converter 430.

The integrated circuit 400 can include a core processor 403, such as, for example, a 4350 dual-thread MIPS processor supporting Blu-ray, HD-DVD and BD graphics, HD-DVD and BD Navigation, interconnectivity, content protection and decryption, and a floating point unit for graphics (font rendering) and JAVA support. The core processor can include a multimedia unit, 42K/16K instruction, 42K data cache, and a 128K read ahead cache (RAC) 404 for performance. The integrated circuit 400 also includes a security circuit 490, still picture decoder 492, and audio decoder 440.

The transport processor 405 receives a media stream via input 402 and is capable of parsing both Blu-ray media streams and HD-DVD media streams. The processor 403 determines whether the media stream is Blu-ray or HD-DVD and configures the transport processor 405.

The security circuit 490 can decrypt both Blu-ray media streams and HD-DVD media streams. The processor 403 determines whether the media stream is Blu-ray or HD-DVD and configures the security circuit 490.

The still picture decoder 492 can decode still pictures from both Blu-ray media streams and HD-DVD media streams. The processor 403 determines whether the media stream is Blu-ray or HD-DVD and configures the still picture decoder 492.

The audio decoder 440 can decode audio data from both Blu-ray media streams and HD-DVD media streams. The processor 403 determines whether the media stream is Blu-ray or HD-DVD and configures the audio decoder 440.

### Video Decoder

The video decoder 450 decodes video elementary streams provided by the video queue 120v. The video decoder 450 can transition from one selected video elementary stream to another. In certain embodiments of the present invention, the video decoder 450 is operable to detect a marker indicating a change of selected video elementary stream in the video queue 120v. Responsive thereto, the video decoder 450 changes the codec associated with the previously selected video elementary stream to a codec associated with the newly selected video elementary stream. In certain embodiments, the arrival of the marker at the video decoder 450 can cause an interrupt. The interrupt can cause the video decoder 450 to switch to the appropriate codec.

The video decoder 450 can be equipped with codecs to decode video data compressed in accordance with Advanced Video Coding (AVC, also known as H.264, and MPEG-4, Part 10), SMPTE VC-1 Advanced Profile Level 4, SMPTE VC-1 Simple Profile to Medium Level, and SMPTE VC-1 Main Profile to High Level. The video decoder 450 can be capable of simultaneous single high definition and standard definition decoding.

The video decoder 450 provides decoded and decompressed video to a video and graphics processor 455. In certain embodiments, the video and graphics processor 455 can provide any of the following features:

Hardware support for two content and user interaction-driven 2D graphics planes with full HD resolution—Presentation Graphics Plane

Foreground (Interactive) Graphics Plane

Vendor OSD graphics overlay plane (in addition to the two planes described above), overlays all graphics and video planes)

Alpha-blending capabilities on all planes

Simultaneous support for HD and SD output of the same content and graphics

Select between overlay plane only or scaled version of composite output for secondary outputs

Video Scaler: Horizontal and vertical with programmable zooming (frame by frame); independently configured for each video stream

Alpha blending capabilities
Three levels of graphics, two video
HD-DVD Clear Rect Function on secondary video plane

Motion adaptive de-interlacer

Thomson Film Grain insertion technology (FGT)

Main Output Compositor with five inputs
Three graphics feeds and two video feeds

Component outputs can output a reduced resolution version of the full HD signal if the corresponding AACS-defined flag is set by the content provider (DVO and HDMI outputs must remain at full resolution).

A single output image is then sent to the VEC (video encoder) which converts it to the various analog and digital output formats (composite video, S-video, RF video, component video, HDMI, DVI, etc).

### Audio Decoder

The audio decoder 440 receives and decodes the audio data from the selected audio elementary streams and provides the decoded audio data to the 8 Channel/Stereo output port 420, SPDIF output port 425, and Stereo Audio Digital Audio Converter 430.

The audio decoder 440 decodes audio elementary streams provided by the audio queue 120a. The audio decoder 440 can transition from one selected audio elementary stream to another. In certain embodiments of the present invention, the audio decoder 440 is operable to detect a marker indicating a change of selected audio elementary stream in the audio queue 120a. Responsive thereto, the audio decoder 440 changes the codec associated with the previously selected audio elementary stream to a codec associated with the newly selected audio elementary stream. In certain embodiments, the arrival of the marker at the audio decoder 440 can cause an interrupt. The interrupt can cause the audio decoder 440 to switch to the appropriate codec.

The audio decoder 440 can include any of the following features:

Audio Standards
LPCM to 7.1 channels
MPEG audio
MPEG-1 Layer Ill (MP3) to stereo
Dolby Digital (AC3) to 5.1 channels
Dolby Digital Plus to 7.1 channels
Dolby TrueHD MLP (Compressed LPCM)—DTS to 5.1 channels

DTS—HD to 7.1 channels
MPEG-4 High-Efficiency AAC to 5.1 channels WMA Pro LPCM
MLP (Compressed LPCM) aka Dolby TrueHD—AAC-HE (IP-STB)
Dolby Digital multi-channel Bass Management support, with equivalent support for DTS
PCM audio mixing and post processing—Primary and Secondary decoded streams with:
   Audio clips input over Host I/F or from stream input
   Individually controlled mixing and fading
Speaker Management Capabilities; minimum support for “Small,” “Large,” and “Off” settings
PCM audio mixing and post-processing
   Mix primary and secondary decoded streams with effects sounds (PCM)
   Individually controlled mixing and fading
Re-encode result of mixed primary and secondary programs and PCM effects for S/PDIF or HDMI output:
   Formats: AC-3 5.1, DTS 5.1

The integrated circuit 400 can include a number of system interfaces, including, for example, Dual SATA interfaces 457, Parallel IDE interface 458, 10/100 Base T Ethernet Port 459, Dual USB 2.0 host ports 460, 42-bit PCI v2.2 43-MHz Master/Target interface/EBI Parallel Bus 462, Dual UART interface/GPIO/User interface pins 464, Serial Controller (SC) ports 465, NAND flash support, external FLASH support. The integrated circuit 400 can also include a number of different memory interfaces, such as DDR Interfaces 467, and SDRAM controllers.

In certain embodiments of the present invention, the integrated circuit can consume 7.0 W in full operation (simultaneous HD and SD decoding, dual audio programs, and full graphics package running). The integrated circuit 400 can also include a power down mode that reduces the power consumption from the active state by a minimum of 90% or the level required by phase 2 of the EnergyStar specification for DVD devices (<1 Watt). In the foregoing state, the processor and user interface remain active. The supply voltage for the core may be 1.2V, the DDR interface 467 supply voltage may be 1.8V, and the PCI/EBI/GPIO interface 462 voltage may be 4V. The integrated circuit 400 can also include a voltage regulator that provides 2.5V from a 4.3V input and outputs it on a power pin for use on the integrated circuit 2.5 inputs.

Various embodiments of the invention comprise a complete system-on-a-chip (SoC) solution that combines both Blu-ray and HD-DVD optical disc formats into a highly integrated, single-chip design. The single chip Blu-ray/HD-DVD SoC solution provides a next-generation universal player SoC that not only significantly surpasses current chip technology in integration and performance but furthers the advancement of high definition media players. The single chip Blu-ray/HD-DVD SoC (or the chip) solution comprises an advanced feature set, coupled with a software stack compliant with both Blu-ray and HD-DVD specifications, that provides OEMs with a complete platform for Blu-ray and HD-DVD media players. This combined Blu-ray/HD-DVD solution provides a foundation for future-generation media players that support both disc formats, as well as other home entertainment and network applications.

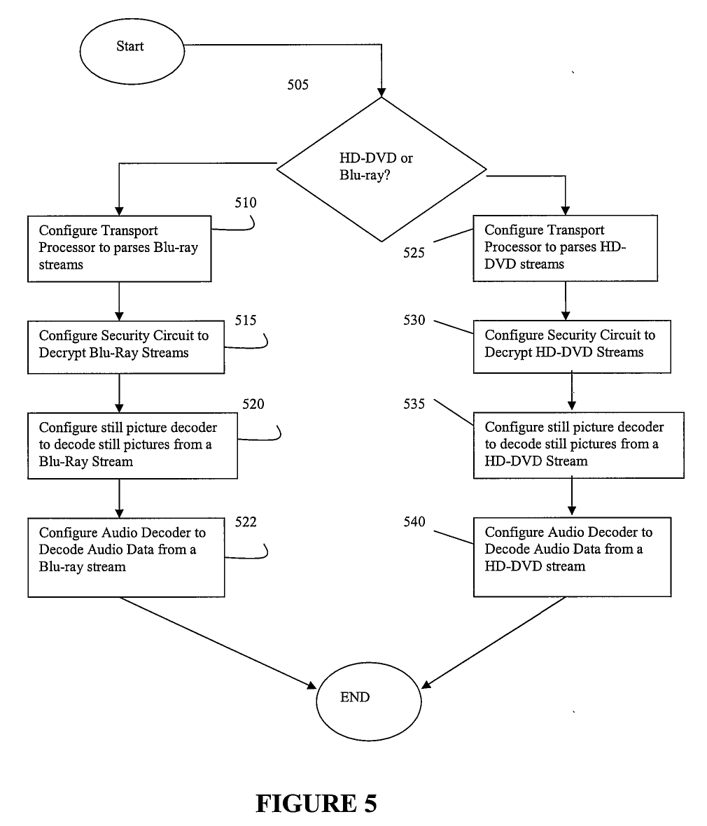

Referring now to FIG. 5, there is illustrated a flow diagram for playing back a media stream in accordance with an embodiment of the present invention. At 505, the host processor 403 determines whether the media stream is Blu-ray or HD-DVD.

If at 505, the host processor 403 determines the media stream is Blu-ray, the host processor 403 configures (510) the transport processor 405 to parse Blu-ray streams, the security circuit 490 to decrypt Blu-ray streams (515), the still picture decoder 492 to decode still pictures from a Blu-Ray stream (520), and the audio decoder 440 to decode audio data from a Blu-ray stream (522).

If at 505, the host processor 403 determines the media stream is HD-DVD, the host processor 403 configures (525) the transport processor 405 to parse HD-DVD streams, the security circuit 490 to decrypt HD-DVD streams (530), the still picture decoder 492 to decode still pictures from a HD-DVD stream (535), and the audio decoder 440 to decode audio data from a HD-DVD stream (540).

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope.

Therefore, it is intended that the present invention not be limited to the particular embodiment disclosed, but that the present invention will include all embodiments falling within the scope of the appended claims.

What is claimed is:

1. An integrated circuit for playing back media, said integrated circuit comprising:
a transport processor for parsing a media stream; and
a host processor for determining whether a media stream is Blu-ray or HD-DVD and configuring the transport processor based on whether the media stream is Blu-ray or HD-DVD.

2. The integrated circuit of claim 1, wherein the transport processor further comprises:
a memory for storing a plurality of instructions, said plurality of instructions comprising a first plurality of instructions for parsing the media stream if the media stream is Blu-ray and a second plurality of instructions for parsing the media stream is the media stream is HD-DVD; and
a controller for executing either the first plurality of instructions if the host processor determines the media stream is Blu-ray or the second plurality of instructions if the host processor determines the media stream is HD-DVD.

3. The integrated circuit of claim 1, wherein the integrated circuit further comprises:
a security circuit for decrypting the media stream; and
wherein the host processor configures the security controller based on whether the media is Blu-ray or HD-DVD.

4. The integrated circuit of claim 1, further comprising:
audio decoder circuitry for decoding audio data from the media stream; and
wherein the host processor configures the audio decoder based on whether the media is Blu-ray or HD-DVD.

5. The integrated circuit of claim 1, further comprising:
a still image decoder for decoding still images from the media stream; and
wherein the host processor configures the still picture decoder based on whether the media is Blu-ray or HD-DVD.

6. A transport processor for parsing a media stream, said transport processor comprising:
a first memory portion storing a first program, said first program for parsing a transport stream;
a second memory portion storing a second program, said second program for parsing a program stream; and
a controller for executing one of the first program or second program.

7. The transport processor of claim 6, wherein the one of the first program or second program is indicated by a signal received by the controller from a host processor.

8. The transport processor of claim 6, wherein execution of the first program by the controller causes parsing of a Blu-ray stream and wherein execution of the second program by the controller causes parsing of an HD=DVD stream.

9. A method for playing back media, said method comprising:
detecting whether a media stream is Blu-ray or HD-DVD;
configuring a transport processor based on whether the media stream is Blu-ray or HD-DVD.

10. The method of claim 9, wherein configuring the transport processor further comprises:
causing the transport processor to execute a first program if the media stream is Blu-ray and a second program if the media stream is HD-DVD.

11. The method of claim 9, said method further comprising:
configuring a security controller based on whether the media is Blu-ray or HD-DVD.

12. The method of claim 9, further comprising:
configuring an audio decoder based on whether the media is Blu-ray or HD-DVD.

13. The method of claim 9, further comprising:
configuring a still picture decoder based on whether the media is Blu-ray or HD-DVD.
